(19) United States
(12) Patent Application Publication
(10) Pub. No.: US 2009/0227334 A1
(43) Pub. Date: Sep. 10, 2009

(54) Gaming Machine Arranging Symbols Based on Rearranged Symbols and Playing Method Thereof

(75) Inventor: Yukinori INAMURA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/248,373

(22) Filed: Oct. 9, 2008

Related U.S. Application Data
(60) Provisional application No. 61/034,400, filed on Mar. 6, 2008.

(51) Int. Cl. A63F 13/00; A63F 9/24

(52) U.S. Cl. 463/20; 463/16

(57) ABSTRACT

A gaming machine includes: a plurality of gaming terminals capable of running a game independently from each other, each of which terminals includes a terminal display having a matrix of arrangement areas and which arranges a plurality of symbols in the arrangement areas; and a shared display for arranging therein a plurality of symbols. In the gaming machine, symbols are rearranged in the arrangement areas of the terminal display of each of the gaming terminals. According to a relation among the symbols rearranged in the arrangement areas, a payout is awarded one symbol arrangement of one gaming terminal is combined with another symbol arrangement of another gaming terminal, and symbols identical to those in the one symbol arrangement and the other symbol arrangement are rearranged on the shared display, wherein the one symbol arrangement includes the symbols arranged in arrangement areas of the one gaming terminal, and the other symbol arrangement includes the symbols arranged in arrangement areas of the other gaming terminal. According to a relation among the symbols rearranged on the shared display, a payout is awarded.

### CROSS REFERENCE TO RELATED APPLICATION

The present application claims priority from Provisional Application No. 61/034,400, which was filed on Mar. 6, 2008, the entire disclosure of which is herein incorporated by reference.

### BACKGROUND OF THE INVENTION

1. Field of the Invention

The present invention relates to a gaming machine and a playing method thereof.

2. Description of Related Art

Among existing gaming machines, there is a gaming machine including: two or more gaming terminals; terminal controllers respectively provided to the gaming terminal, each of which controllers causes associated one of the gaming terminals to run a game; a center controller for controlling all the terminal controllers. This type of gaming machine is disclosed in specifications of U.S. Pat. No. 5,820,459, U.S. Pat. No. 4,283,709, or U.S. Pat. No. 6,003,013. A terminal controller of a gaming terminal runs a game and awards a payout based on the result of the game independently from another terminal controller of another gaming terminal. The center controller provides various jackpots such as progressive jackpots, mystery jackpots, or the like.

An object of the invention is to provide a gaming machine providing an entertainment characteristic which is not brought about by the above mentioned prior art, and a playing method thereof.

Another object of the invention is to provide a gaming machine and a playing method thereof each involving two or more gaming terminals to play a single game, which thereby realizes a new entertainment characteristic that gives the feelings of “unity” and “sharing” to participating players.

### SUMMARY OF THE INVENTION

A gaming machine of the present invention, comprises:

a plurality of gaming terminals capable of running a game independently from each other, each of which terminals includes a terminal display having a matrix of arrangement areas and which arranges a plurality of symbols in the arrangement areas;

a shared display for arranging therein a plurality of symbols;

a center controller programmed to perform the steps of:

(a1) rearranging symbols in the arrangement areas of each of the gaming terminals, based on running of a game in the gaming terminal;

(a2) awarding a payout according to a relation among the symbols rearranged in the arrangement areas;

(a3) combining one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and

(a4) awarding a payout according to a relation among the symbols rearranged on the shared display.

In the above structure, a game is run in each of the gaming terminals. Based on the running of the game, symbols are rearranged in the arrangement areas on the terminal display of the gaming terminal. Then, a payout is awarded according to a relation among the symbols rearranged in the arrangement areas. On the shared display are rearranged symbols identical to those in one symbol arrangement of one gaming terminal in combination with symbols identical to those in another symbol arrangement of another gaming terminal. Then, a payout is awarded according to a relation among the symbols rearranged on the shared display. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the symbols identical to those in the symbol arrangement of the one gaming terminal in combination with the symbols identical to those in the other symbol arrangement of the other gaming terminal. This realizes a new entertainment characteristic which gives the feelings of “unity” and “sharing” to participating players.

The present invention is a gaming machine including: a plurality of gaming terminals capable of running a game independently from each other, each of which terminals includes a terminal display having a matrix of arrangement areas and which arranges a plurality of symbols in the arrangement areas; a shared display for arranging therein a plurality of symbols; and a controller programmed to perform the steps of:

(b1) rearranging symbols in the arrangement areas of each of the gaming terminals, based on running of a game in the gaming terminal;

(b2) awarding a payout according to a relation among the symbols rearranged in the arrangement areas;

(b3) combining, on the row or column basis, one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and

(b4) awarding a payout according to a relation among the symbols rearranged on the shared display.

In the above structure, a game is run in each of the gaming terminals. Based on the running of the game, symbols are rearranged in the arrangement areas on the terminal display of the gaming terminal. Then, a payout is awarded according to a relation among the symbols rearranged in the arrangement areas. On the shared display are rearranged (i) symbols identical to those in one symbol arrangement of one gaming terminal and (ii) symbols identical to those in another symbol arrangement of another gaming terminal. The (i) and (ii) are combined on the row or column basis. Then, a payout is awarded according to a relation among the symbols rearranged on the shared display. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the symbols identical to those in the symbol arrangement of the one gaming terminal in combination with the symbols identical to those in the other symbol arrangement of the other gaming terminal. This realizes a new entertainment characteristic which gives the feelings of “unity” and “sharing” to participating players. The structure further realizes a new entertainment characteristic which allows each player to easily understand how rearranged symbols on the terminal displays are combined and rearranged on the shared display. This characteristic enhances the feelings of “unity” and “sharing” among the players.

The present invention is a gaming machine, including:

a plurality of gaming terminals capable of running a game independently from each other, each of which terminals includes a terminal display having a matrix of arrangement areas and which arranges a plurality of symbols in the arrangement areas;

a shared display for arranging therein a plurality of symbols;

a controller programmed to perform the steps of:

(c1) rearranging symbols in the arrangement areas of each of the gaming terminals, based on running of a game in the gaming terminal;

(c2) awarding a payout according to a relation among the symbols rearranged in the arrangement areas;

(c3) combining a symbol arrangement of one gaming terminal with another symbol arrangement of another gaming terminal, and rearranging, on the shared display, symbols corresponding to those in the one symbol arrangement and the other symbol arrangement, wherein the one symbol arrangement includes symbols arranged on the one gaming terminal, and the other symbol arrangement includes symbols arranged on the other gaming terminal; and the positions of the one symbol arrangement and the other symbol arrangement along x coordinate axis or y coordinate axis are different from each other; and

(c4) awarding a payout according to a relation among the symbols rearranged on the shared display.

In the above structure, a game is run in each of the gaming terminals. Based on the running of the game, symbols are rearranged in the matrix of the arrangement areas on the terminal display of the gaming terminal. Then, a payout is awarded according to a relation among the symbols rearranged in the arrangement areas. On the shared display are rearranged symbols identical to those in one symbol arrangement of one gaming terminal and symbols identical to those in another symbol arrangement of another gaming terminal. The positions of the one symbol arrangement of one gaming terminal and the other symbol arrangement of the other gaming terminal along the x coordinate axis or y coordinate axis are different from each other. Then, a payout is awarded according to a relation among the symbols rearranged on the shared display. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the symbols identical to those in the one symbol arrangement of the one gaming terminal in combination with the symbols identical to those in the other symbol arrangement of the other gaming terminal, the positions of the one symbol arrangement and the other symbol arrangement along x coordinate axis or y coordinate axis being different from each other. This realizes a new entertainment characteristic which gives the feelings of “unity” and “sharing” to participating players.

The present invention is a gaming machine, including:

a plurality of gaming terminals capable of running a game independently from each other, each of which terminals includes a terminal display having a matrix of arrangement areas and which arranges a plurality of symbols in the arrangement areas;

a shared display for arranging therein a plurality of symbols;

a controller programmed to perform the steps of:

(d1) rearranging symbols in the arrangement areas of each of the gaming terminals, based on running of a game in the gaming terminal;

(d2) awarding a payout according to a relation among the symbols rearranged in the arrangement areas;

(d3) combining a symbol arrangement of one gaming terminal with another symbol arrangement of another gaming terminal, and rearranging, on the shared display, symbols corresponding to those in the one symbol arrangement and the other symbol arrangement, wherein the one symbol arrangement includes symbols arranged in a row or a column on the one gaming terminal, and the other symbol arrangement includes symbols arranged in a row or a column on the other gaming terminal; and the positions of the one symbol arrangement and the other symbol arrangement along x coordinate axis or y coordinate axis are different from each other; and

(d4) awarding a payout according to a relation among the symbols rearranged on the shared display.

In the above structure, a game is run in each of the gaming terminals. Based on the running of the game, symbols are rearranged in the matrix of the arrangement areas on the terminal display of the gaming terminal. Then, a payout is awarded according to a relation among the symbols rearranged in the arrangement areas. On the shared display are rearranged one symbol arrangement including symbols arranged in a row or a column on one gaming terminal and another symbol arrangement including symbols arranged in a row or a column on another gaming terminal. The positions of the one symbol arrangement and the other symbol arrangement along x coordinate axis or y coordinate axis are different from each other. Then, a payout is awarded according to a relation among the symbols rearranged on the shared display. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the one symbol arrangement of the one gaming terminal in combination with the other symbol arrangement of the other gaming terminal, the one symbol arrangement including symbols arranged in a row or a column on the one gaming terminal, the other symbol arrangement including symbols arranged in a row or a column of the other gaming terminal, and the positions of the one symbol arrangement and the other symbol arrangement along the x coordinate axis or y coordinate axis being different from each other. This realizes a new entertainment characteristic which gives the feelings of “unity” and “sharing” to participating players.

The structure further realizes a new entertainment characteristic which allows each player to easily understand how rearranged symbols on the terminal displays are combined and rearranged on the shared display. This characteristic enhances the feelings of “unity” and “sharing” among the players.

The present invention is a playing method of a gaming machine, in which a plurality of symbols are arranged in a matrix of arrangement areas on terminal displays of a plurality of gaming terminals,

the method including the steps of:

(e1) rearranging symbols in the arrangement areas of each of the gaming terminals, based on running of a game in the gaming terminal;

(e2) awarding a payout according to a relation among the symbols rearranged in the arrangement areas;

(e3) combining one symbol arrangement of one gaming terminal with another symbol arrangement of another gaming terminal, and rearranging, on a shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and

(e4) awarding a payout according to a relation among the symbols rearranged on the shared display.

Accordingly, the payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the symbols identical to those in the symbol arrangement of the one gaming terminal in combination with the symbols identical to those in the other symbol arrangement of the other gaming terminal. This realizes a new entertainment characteristic which gives the feelings of “unity” and “sharing” to participating players.

The present invention is a gaming machine, including

a plurality of gaming terminals each including (i) a terminal display having a matrix of arrangement areas, which rearranges a plurality of symbols in the arrangement areas, and (ii) a terminal controller; a shared display for arranging therein a plurality of symbols; a center controller, wherein:

the terminal controller is programmed to perform the steps of

(f1) rearranging symbols in the arrangement areas at a predetermined timing,

(f2) awarding a payout according to a relation among the symbols rearranged in the arrangement areas, and

(f3) when a predetermined condition is met, transmitting to the center controller symbols arranged in the arrangement areas and an arrangement of the symbols; and

the center controller is programmed to perform the steps of

(g1) when the predetermined condition is met, receiving from each of the gaming terminals symbols arranged in the arrangement areas and an arrangement of the symbols,

(g2) combining one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal, and

(g3) awarding a payout according to a relation among the symbols rearranged in the shared display.

According to the above structure, symbols are rearranged at a predetermined timing in the arrangement areas on the terminal display of the gaming terminal. Then, a payout is awarded according to a relation among the symbols rearranged in the arrangement areas. When a predetermined condition is met, symbols identical to those in one symbol arrangement of one gaming terminal are rearranged on the shared display in combination with symbols identical to those in another symbol arrangement of another gaming terminal. Then, a payout is awarded according to a relation among the symbols rearranged on the shared display. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals by rearranging, on the shared display, the symbols identical to those in the symbol arrangement of the one gaming terminal in combination with the symbols identical to those in the other symbol arrangement of the other gaming terminal. This realizes a new entertainment characteristic which gives the feelings of “unity” and “sharing” to participating players.

### BRIEF DESCRIPTION OF THE DRAWINGS

FIG. 1 illustrates a gaming machine and a playing method thereof, according to the present invention.

FIG. 2 is a block diagram of the gaming machine.

FIG. 3 is an explanatory diagram illustrating a display state of a terminal display during a base game.

FIG. 4 is an explanatory diagram illustrating a display state of a shared display.

FIG. 5 is an explanatory diagram illustrating an alternative form of a combination symbol arrangement 190.

FIG. 6 is an explanatory diagram illustrating a pattern of combining two or more combination symbol arrangements 190.

FIG. 7 is a perspective view illustrating an external appearance of the gaming machine.

FIG. 8 is a perspective view illustrating an external appearance of the gaming terminal.

FIG. 9 is an explanatory diagram illustrating a symbol column of symbols rearranged on the terminal display.

FIG. 10 is a block diagram illustrating an electrical structure of the gaming terminal.

FIG. 11 is a block diagram illustrating an electrical structure of a center controller.

FIG. 12 is a flowchart illustrating a boot process executed by a gaming terminal and the center controller.

FIG. 13 is a flowchart illustrating an initial process executed by the gaming terminal and the center controller.

FIG. 14 is a flowchart illustrating a terminal process routine executed in the gaming terminal.

FIG. 15 is a flowchart illustrating a center process routine executed in the center controller.

### DESCRIPTION OF THE PREFERRED EMBODIMENTS

The following describes an embodiment of a gaming machine and a playing method thereof according to the present invention.

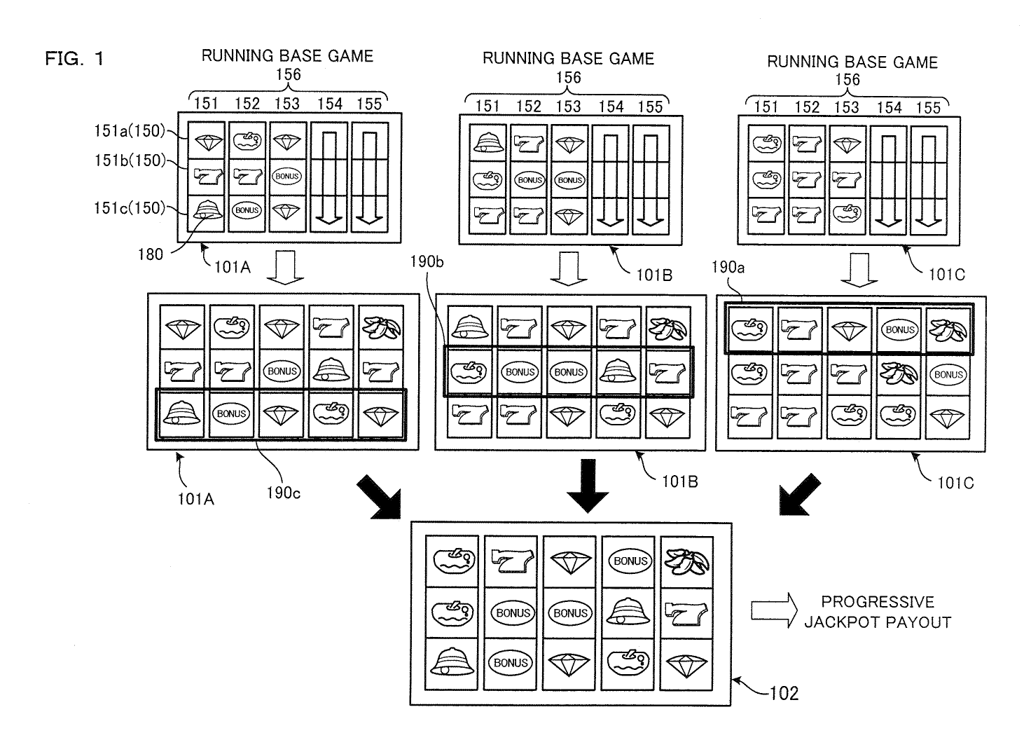

As illustrated in FIG. 1, a gaming machine 1 includes a plurality of gaming terminals 3 and a shared display 102, and executes a playing method including the steps of: arranging symbols 180 in arrangement areas 150 of each of the gaming terminals 3 based on running of a game; awarding a payout according to a relation among the symbols 180 rearranged in the arrangement areas 150; combining a symbol arrangement 190 of one gaming terminal 3 with another symbol arrangement 190 of another gaming terminal 3, and rearranging, on the shared display 102, symbols 180 corresponding to those in the one symbol arrangement 190 and the other symbol arrangement 190, wherein the one symbol arrangement 190 includes symbols 180 arranged in a row or a column on the one gaming terminal 3, and the other symbol arrangement includes symbols 180 arranged in a row or a column on the other gaming terminal 3; and the positions of the one symbol arrangement 190 and the other symbol arrangement 190 along x coordinate axis or y coordinate axis are different from each other; and awarding a payout according to a relation among the symbols 180 rearranged on the shared display 102.

The “arranging” in this specification means a state where the symbols 180 can be visually observed by a player. That is, the wording means a state where the symbols 180 are displayed in the arrangement areas 150, in FIG. 1. Arranging the symbols 180 again after dismissing the symbols 180 is referred to as rearranging.

As illustrated in FIG. 1, the arrangement areas 150 are areas of a terminal display 101 where symbols 180 are arranged. The arrangement areas 150 form display windows 151 to 155 as illustrated in FIG. 1. For example, arrangement areas 151a, 151b, and 151c form the display window 151. Further, the display windows 151 to 155 form a matrix 156. The matrix 156, in other words, is formed with the plurality of arrangement areas 150 arranged in a matrix.

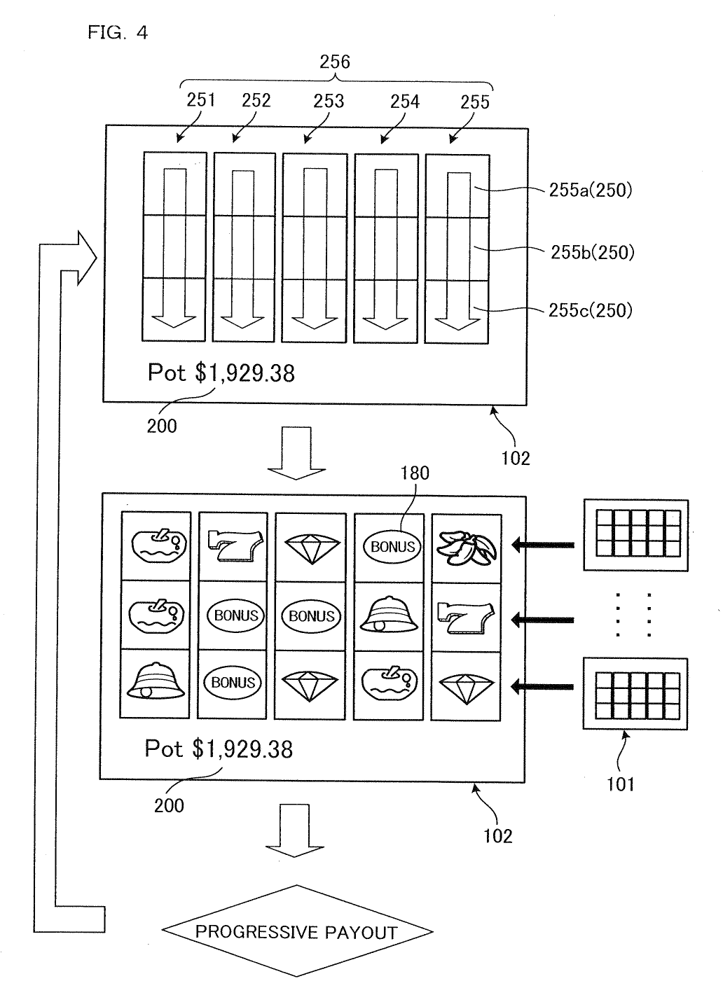

As illustrated in FIG. 4, arrangement areas 250 are areas of the shared display 102 where symbols 180 are arranged. The arrangement areas 150 form display windows 251 to 255 as illustrated in FIG. 4. For example, the arrangement areas 255a, 255b, and 255c form the display window 255. Further, the display windows 251 to 255 form a matrix 256. The matrix 256, in other words, is formed with the plurality of arrangement areas 250 arranged in a matrix.

Further, “scatter symbols” are such symbols which provide advantages to a player when a predetermined number or more of them are displayed in the matrix 156. For example, the advantages includes: a state where coins corresponding to the scatter symbols are paid out, a state where the number of coins to be paid out is added to a credit, a state where a bonus game is started.

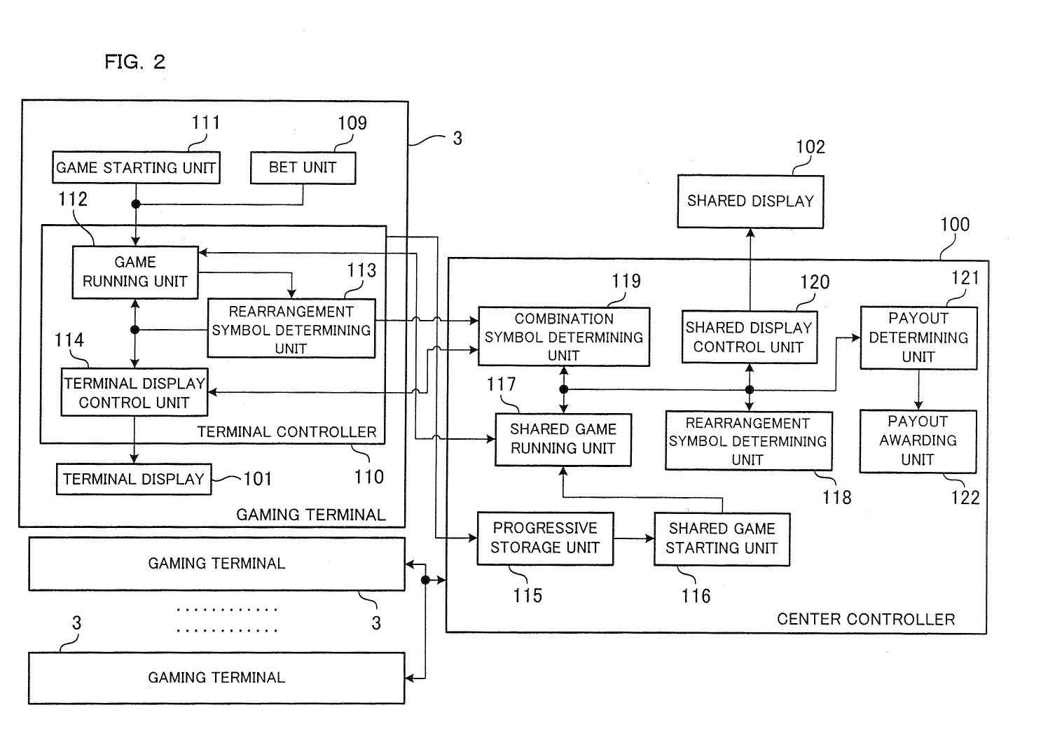

As illustrated in FIG. 2, the gaming machine 1 which executes the playing method has the shared display 102, a center controller 100, and gaming terminals 3. Each of the gaming terminals 3 includes a terminal display 101 and a terminal controller 110.

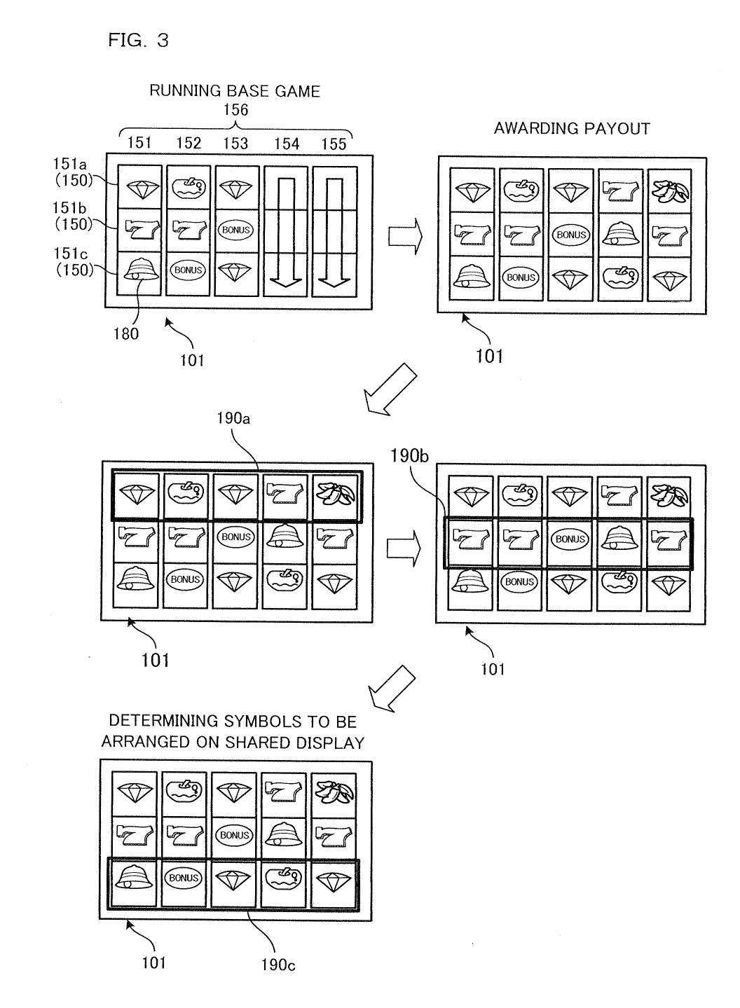

As illustrated in FIG. 3, the terminal display 101 has the arrangement areas 150, and symbols 180 are arranged in the arrangement areas 150.

The terminal display 101 may have a mechanical structure adopting a reel device which rotates a reel to arrange the symbols 180. Alternatively, the terminal display 101 may have an electric structure in which a video reel is displayed as an image and symbols 180 on a video reel are arranged in the form of an image. Further, the terminal display 101 may adopt a combination of the mechanical structure (reel) and the electrical structure (video reel). Examples of the electrical structure include a liquid crystal display device, a CRT (cathode-ray tube), a plasma display device, or the like. Further, the number of arrangement areas 150 is not limited. A specific structure of the terminal display 101 will be detailed later.

As illustrated in FIG. 4, the shared display 102 has the arrangement areas 250, and symbols 180 are arranged in the arrangement areas 250. This shared display 102 displays a progressive jackpot value 200 as illustrated in FIG. 4. A specific structure of the terminal display 101 will be detailed later.

[Terminal Controller 100] The terminal controller 100 executes: a first process of rearranging symbols 180 in arrangement areas 150 at a predetermined timing; a second process of awarding a payout according to a relation among the symbols 180 rearranged in the arrangement areas 180; and a third process of, when a predetermined condition is met, transmitting information of symbols 180 rearranged in the arrangement areas 150 and an arrangement of the rearranged symbols 180 to the center controller 100. In other words, the terminal controller 110 has a first processing unit, a second processing unit and a third processing unit.

The terminal controller 110 is connected to a center controller 100 and is in communication with the center controller 100.

As illustrated in FIG. 2, the terminal controller 110 is connected to a game starting unit 111. The game starting unit 111 has a function of outputting a game start signal, in response to an operation by the player. The game start signal output is then input to a later-described game running unit 112.

Further, the terminal controller 110 is connected to a BET unit 109. The BET unit 109 has functions of receiving a bet entered through an operation by the player, and outputting a BET signal in response to the bet entered. The BET signal output is input to a later-described game running unit 112.

The terminal controller 110 includes: a game running unit 112, a rearrangement symbol determining unit 113, and a terminal display control unit 114. The game running unit 112 runs a base game, triggered by a game start signal from the game starting unit 111. In the base game, symbols 180 are rearranged in the arrangement areas 150 of the terminal display 101. Further, the terminal controller 110 outputs a progressive signal, triggered by the game start signal. The progressive signal is a signal indicating a game value.

The rearrangement symbol determining unit 113 determines, based on the state of game run by the game running unit 112, a plurality of symbols 180 to be rearranged in the arrangement areas 150 and an arrangement of the symbols 180 (hereinafter, terminal symbol arrangement). The terminal controller 110 then transmits information of the terminal symbol arrangement to the center controller 100, through a control performed by the game running unit 112.

The terminal display control unit 114 displays the symbols 180 on the terminal display 101 under control of the game running unit 112 and on the basis of a determination of the rearrangement symbol determining unit 113. A detailed display state will be detailed later.

Further, the terminal controller 110 includes a not-shown payout award determining unit and a payout awarding unit. The payout award determining unit determines whether to award a payout, based on a relation among the symbols 180 rearranged in the arrangement areas 150 of the terminal display 101. Then, the payout awarding unit awards a payout based on a determination of the payout award determining unit.

Meanwhile, each block of the terminal controller 110 may be realized with hardware or with software as needed.

[Operation of Terminal Controller 110] The following describes an operation of the terminal controller 100 in the above structure. First, the BET unit 109 accepts a BET entered through an operation by a player. Then, in response to the operation, the game starting unit 111 outputs a game start signal to cause the game running unit 112 to start a base game. When the base game is started, the rearrangement symbol determining unit 113 determines symbols 180 to be rearranged in the arrangement areas 150 and an arrangement of the symbols 180 (terminal symbol arrangement). The symbols 180 to be rearranged and the terminal symbol arrangement are determined at every base game. The symbols 180 determined by the rearrangement symbol determining unit 113 undergo an image processing in the terminal display control unit 114, and are displayed on the terminal display 101. The terminal display control unit 114 rearranges the symbols 180 in the arrangement areas 150, according to the arrangement determined. Thus, the terminal controller 110 executes the first process of rearranging symbols 180 in the arrangement areas 150 at a predetermined timing.

Further, a not-shown payout determining unit determines whether to award a payout according to a relation among the symbols 180 rearranged in the arrangement areas 150. When the payout determining unit determines to award a payout, a not-shown payout awarding unit awards a payout. Thus, the terminal controller 110 executes the second process of awarding a payout according to a relation among the symbols 180 rearranged in the arrangement areas 150.

Further, the terminal controller 110 transmits, to the center controller 100, symbols 180 determined by the rearrangement symbol determining unit 113 and an arrangement of the symbols 180, based on a predetermined condition. An example of such a condition is a shared game being run, or the like condition. Thus, the terminal controller 110 executes the third process of, when a predetermined condition is met, transmitting symbols 180 determined and an arrangement of the symbols 180 to the center controller 100.

[Operation of Center Controller 100]

When the predetermined condition is met, the center controller 100 executes: fourth process of receiving symbols 180 and an arrangement of the symbols from one or more terminal controllers 110; a fifth process of combining a symbol arrangement 190 of one gaming terminal 3 with another symbol arrangement 190 of another gaming terminal 3, and rearranging, on the shared display 102, symbols 180 corresponding to those in the one symbol arrangement 190 and the other symbol arrangement 190, wherein the one symbol arrangement 190 includes symbols 180 arranged in a row or a column on the one gaming terminal 3, and the other symbol arrangement includes symbols 180 arranged in a row or a column on the other gaming terminal 3; and the positions of the one symbol arrangement 190 and the other symbol arrangement 190 along x coordinate axis or y coordinate axis are different from each other; and a sixth process of awarding a payout according to a relation among the symbols rearranged on the shared display 102. In other words, the terminal controller 100 includes a fourth process unit, a fifth process unit, and a sixth process unit.

As illustrated in FIG. 2, the center controller 100 is connected to the terminal controller 110 and is in communication with the terminal controller 110.

The center controller 100 includes: a progressive storage unit 115, a shared game starting unit 116, a shared game running unit 117, a rearrangement symbol determining unit 118, combination symbol determining unit 119, a shared display control unit 120, a payout determining unit 121, and a payout awarding unit 122.

The progressive storage unit 115 stores and sums up a game value indicated by a progressive signal received from the terminal controller 110. The shared game starting unit 116 outputs a shared game start signal, when the predetermined condition is met. The shared game start signal output is input to a later-mentioned shared game running unit 117. For example, meeting the predetermined situation means a situation where a game value stored in the progressive storage unit 115 sums up to a predetermined value or greater.

The shared game running unit 117 runs a shared game, triggered by the shared game start signal received from the shared game starting unit 116. In the shared game, symbols 180 are rearranged in the arrangement areas 250 of the shared display 102.

The combination symbol determining unit 119 receives information of a terminal symbol arrangement from each of two or more terminal controllers 110. Based on the information of the terminal symbol arrangement received, the combination symbol determining unit 119 selects symbols 180 and determines an arrangement of the symbols 180 (hereinafter, combination symbol arrangement 190). In other words, the combination symbol determining unit 119 determines at least two combination symbol arrangements 190.

The rearrangement symbol determining unit 118 determines symbols 180 to be rearranged in arrangement areas 250 and an arrangement of the symbols 180 by combining the at least two combination symbol arrangements 190.

The shared display control unit 120 displays the symbols 180 on the shared display 102 under control of the shared game running unit 117 and on the basis of a determination of the rearrangement symbol determining unit 118. A detailed display state will be detailed later.

The payout determining unit 121 determines whether to award a progressive payout based on a relation among the symbols 180 rearranged in the arrangement areas 250 of the shared display 102. Then, the payout awarding unit 122 awards a progressive payout based on a determination of the payout determining unit 121.

Meanwhile, each block of the center controller 100 may be realized with hardware or with software as needed.

[Operation of Center Controller 100] The following describes an operation of the center controller 100 in the above structure. First, the game value is stored and summed in the progressive storage unit 115. A shared game starts when the stored game value sums up to a predetermined value or greater. The combination symbol determining unit 119, during the shared game, receives information of a terminal symbol arrangement from the terminal controller 110. Thus, the center controller 100 executes the fourth process of receiving, when a predetermined condition is met, symbols 180 and arrangements thereof (terminal symbol arrangements) from the terminal controllers 110.

The combination symbol determining unit 119 determines at least two combination symbol arrangements 190 based on the terminal symbol arrangement received. Further, the combination symbol determining unit 119 may determine the at least two combination symbol arrangements 190 based on symbols 180 and arrangement thereof in different positions along x coordinate axis or y coordinate axis of the arrangement areas 150. Further, the combination symbol determining unit 119 may determine the at least two combination symbol arrangements 190 on the row or column basis.

The rearrangement symbol determining unit 118 determines symbols 180 to be rearranged in the arrangement areas 250 and an arrangement of the symbols 180, by combining the at least two combination symbol arrangements 190.

The symbols determined by the rearrangement symbol determining unit 118 undergo image processing performed in the shared display control unit 120, and are displayed on the shared display 102. According to the arrangement thus determined, the shared display control unit 120 rearranges the symbols 180 in the arrangement areas 250. Thus, the center controller 100 executes the fifth process of combining a symbol arrangement 190 of one gaming terminal 3 with another symbol arrangement 190 of another gaming terminal 3, and rearranging, on the shared display 102, symbols 180 corresponding to those in the one symbol arrangement 190 and the other symbol arrangement 190, wherein the one symbol arrangement 190 includes symbols 180 arranged in a row or a column on the one gaming terminal 3, and the other symbol arrangement includes symbols 180 arranged in a row or a column on the other gaming terminal 3; and the positions of the one symbol arrangement 190 and the other symbol arrangement 190 along x coordinate axis or y coordinate axis are different from each other.

The payout determining unit 121 determines whether to award a progressive payout, according to a relation of the symbols 180 rearranged in the arrangement areas 250. If the payout determining unit 121 determines to award a progressive payout, the payout awarding unit 122 awards the progressive payout. In other words, the center controller 100 executes the sixth process of awarding a payout according to a relation among the symbols 180 rearranged on the shared display 102.

The above can be rephrased as follows. The center controller 100 causes the terminal controllers 110 to perform the first process so as to execute a seventh process of rearranging symbols 180 in the arrangement areas 150 based on running of a game in the gaming terminals 3.

As is obvious from the above operation, the gaming machine 1 includes a plurality of gaming terminals 3 and a shared display 102, and realizes a playing method including the steps of: rearranging symbols 180 in arrangement areas 150 at a predetermined timing; awarding a payout according to a relation among the symbols 180 rearranged in the arrangement areas 150; transmitting to the center controller 100, the symbols 180 rearranged in the arrangement areas 150 and an arrangement of the symbols 180, when a predetermined condition is met; receiving, from terminal controllers 110, symbols 180 and arrangements thereof, when a predetermined condition is met; combining a symbol arrangement 190 of one gaming terminal 3 with another symbol arrangement 190 of another gaming terminal 3, and rearranging, on the shared display 102, symbols 180 corresponding to those in the one symbol arrangement 190 and the other symbol arrangement 190, wherein the one symbol arrangement 190 includes symbols 180 arranged in a row or a column on the one gaming terminal 3, and the other symbol arrangement includes symbols 180 arranged in a row or a column on the other gaming terminal 3; and the positions of the one symbol arrangement 190 and the other symbol arrangement 190 along x coordinate axis or y coordinate axis are different from each other; and awarding a payout according to a relation among the symbols 180 rearranged on the shared display 102.

This can be rephrased as follows. The gaming machine 1 includes a plurality of gaming terminals 3 and a shared display 102, and realizes a playing method including the steps of: arranging symbols 180 in arrangement areas 150 of each of the gaming terminals 3 based on running of a game; awarding a payout according to a relation among the symbols 180 rearranged in the arrangement areas 150; combining a symbol arrangement 190 of one gaming terminal 3 with another symbol arrangement 190 of another gaming terminal 3, and rearranging, on the shared display 102, symbols 180 corresponding to those in the one symbol arrangement 190 and the other symbol arrangement 190, wherein the one symbol arrangement 190 includes symbols 180 arranged in a row or a column on the one gaming terminal 3, and the other symbol arrangement includes symbols 180 arranged in a row or a column on the other gaming terminal 3; and the positions of the one symbol arrangement 190 and the other symbol arrangement 190 along x coordinate axis or y coordinate axis are different from each other; and awarding a payout according to a relation among the symbols 180 rearranged on the shared display 102.

According to the above playing method, symbols are arranged at a predetermined timing in the arrangement areas 150 on a terminal display 101 of a gaming terminal 3. Then, a payout is awarded according to the symbols 180 rearranged in the arrangement areas 150. On the shared display 102 are rearranged one symbol arrangement 190 including symbols 180 arranged in a row or a column on one gaming terminal 3 and another symbol arrangement 190 including symbols 180 arranged in a row or a column on another gaming terminal 3. The positions of the one symbol arrangement 190 and the other symbol arrangement 190 along x coordinate axis or y coordinate axis are different from each other. Then, a payout is awarded according to the symbols 180 rearranged on the shared display 102. This payout awarded according to the relation among the symbols rearranged on the shared display realizes a new entertainment characteristic which raises player's expectation for another payout in addition to the one awarded as a result of the game run in the gaming terminal. Further, the above structure creates a single game involving a plurality of gaming terminals 3 by rearranging, on the shared display 102, the one symbol arrangement 190 of the one gaming terminal 3 in combination with the other symbol arrangement 190 of the other gaming terminal 3, the one symbol arrangement 190 including symbols 180 arranged in a row or a column on the one gaming terminal 3, the other symbol arrangement 190 including symbols 180 arranged in a row or a column of the other gaming terminal 3, and the positions of the one symbol arrangement 190 and the other symbol arrangement 190 along the x coordinate axis or y coordinate axis being different from each other. This realizes a new entertainment characteristic which gives the feelings of “unity” and “sharing” to participating players. The structure further realizes a new entertainment characteristic which allows each player to easily understand how rearranged symbols on the terminal displays are combined and rearranged on the shared display. This characteristic enhances the feelings of “unity” and “sharing” among the players.

[Display State of Terminal Display 101] The following details an exemplary display state of the terminal display 101 during the operations of the gaming machine 1 and the playing method thereof. Note that the following example deals with a case where the terminal display 101 adopts a video reel and arranges symbols on a video reel in the form of an image, as illustrated in FIG. 3.

As illustrated in FIG. 3, a matrix 156 is in the center of the terminal display 101. The matrix 156 includes a symbol column having symbols 180, which is scrolled as illustrated in the upper left of FIG. 3. The display windows 151 to 155 are respectively divided into upper stages 151a to 155a, central stages 151b to 155b, and lower stages 151c to 155c. The symbols 180 are stopped (arranged) in the stages 151a to 155a, 151b to 155b, and 151c to 155c, respectively. For example, in FIG. 3, “DIAMOND” is stopped in 151a of the upper stage of the display window 151, “7” is stopped in 152b of the central stage of the display window 152 and “DIAMOND” is stopped in 153c of the lower stage of the display window 153. In short, the matrix 156 is a symbol matrix including five columns/three rows. The matrix 156 however is not limited to the one with the five-columns/three-rows.

As is illustrated in the upper left of FIG. 3, the terminal display 101 variably displays symbols 180 when a base game is started in the gaming terminal 3. When this variable-displaying of symbols 180 stops, symbols 180 are rearranged in the arrangement areas 150, as illustrated in FIG. 3. Then, a payout according to a relation among the symbols 180 is awarded.

A frame including a part of the symbols 180 thus rearranged is variably displayed. Then, symbols 180 and an arrangement thereof within the frame, at the time of stopping the variable-displaying, are determined as a combination symbol arrangement 190. Specifically, in the example shown in the middle left of FIG. 3, a combination symbol arrangement 190a is an arrangement of symbols 180 rearranged in those arrangement areas 151a to 155a within the frame. Further, in the example shown in the middle right of FIG. 3, a combination symbol arrangement 190b is an arrangement of symbols 180 rearranged in those arrangement areas 151b to 155b within the frame. Further, in the example shown in the lower left of FIG. 3, a combination symbol arrangement 190c is an arrangement of symbols 180 rearranged in those arrangement areas 151c to 155c within the frame.

[Display State of Shared Display 102] The following details an exemplary display state of the shared display 102 during the operations of the gaming machine 1 and the playing method thereof. Note that the following example deals with a case where the shared display 102 adopts a video reel and arranges symbols on a video reel in the form of an image, as illustrated in FIG. 4.

As illustrated in FIG. 4, a matrix 256 is in the center of the shared display 102. The matrix 256 includes a symbol column having symbols 180, which is scrolled as illustrated in the upper view of FIG. 4. The display windows 251 to 255 are divided into upper stages 251a to 255a, central stages 251b to 255b, and lower stages 251c to 255c. The symbols 180 are stopped (arranged) in the stages 251a to 255a, 251b to 255b, and 251c to 255c, respectively. In short, the matrix 256 is a symbol matrix including five columns/three rows. The matrix 256 however is not limited to the one with the five-columns/three-rows.

This shared display 102 displays at its lower part a progressive jackpot value 200 as illustrated in FIG. 4. The progressive jackpot value 200 is the sum of game values having been accumulated. In FIG. 4 for example, the progressive jackpot value 200 is 1,929.38 dollars.

As is illustrated in the upper view of FIG. 4, the shared display 102 variably displays symbols 180 when a shared game is started. When this variable-displaying of symbols 180 stops, symbols 180 are rearranged in the arrangement areas 250, as illustrated in FIG. 4. Symbols 180 are rearranged in the arrangement areas 250, by combining the combination symbol arrangements 190 of the terminal displays 101. Then, a progressive payout is awarded according to a relation among the symbols 180 rearranged.

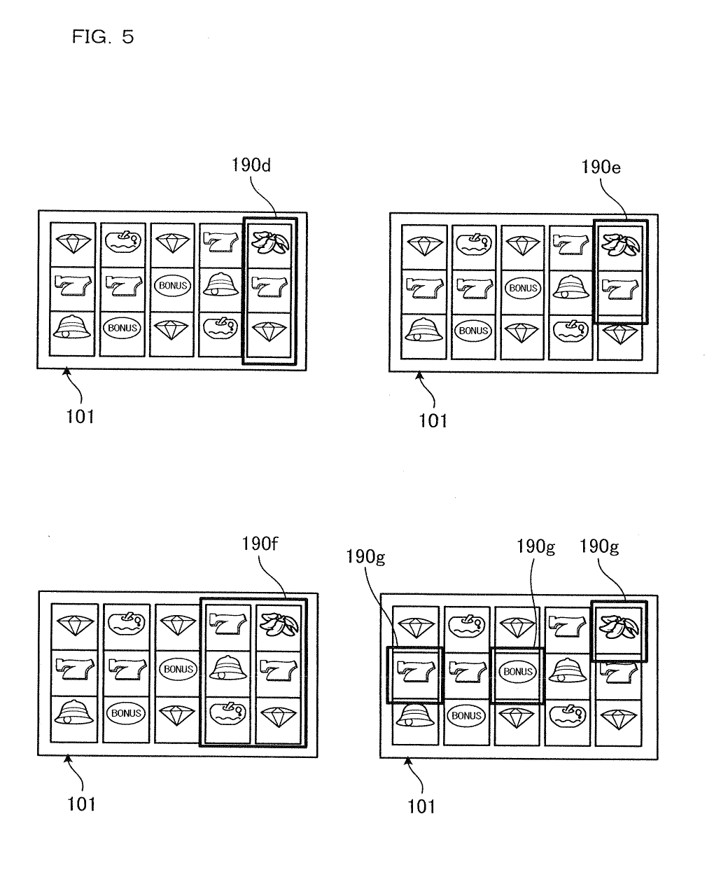

As is the case of combination symbol arrangements 190a to 190c illustrated in FIG. 3, the combination symbol arrangement 190 may be an arrangement of one or more rows. Alternatively, the combination symbol arrangement 190 may be an arrangement of one or more columns, or adjacent or separate groups of arrangement areas, as is the case of combination symbol arrangements 190d to 190g illustrated in FIG. 5. The combination symbol arrangements 190 on the row or column basis allows players to easily understand how rearranged symbols 180 on the terminal displays 101 are combined and rearranged on the shared display 102. This enhances the feelings of “unity” and “sharing” among participating players.

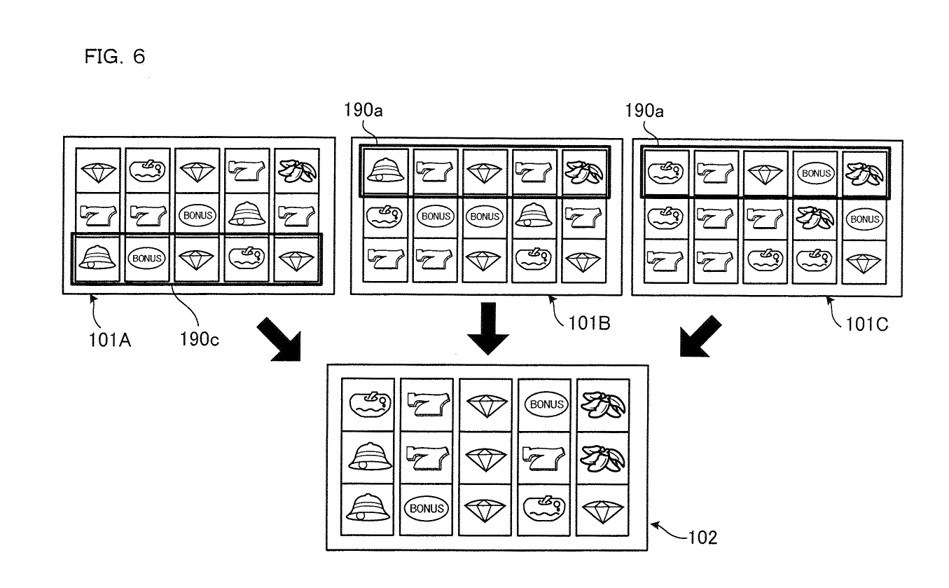

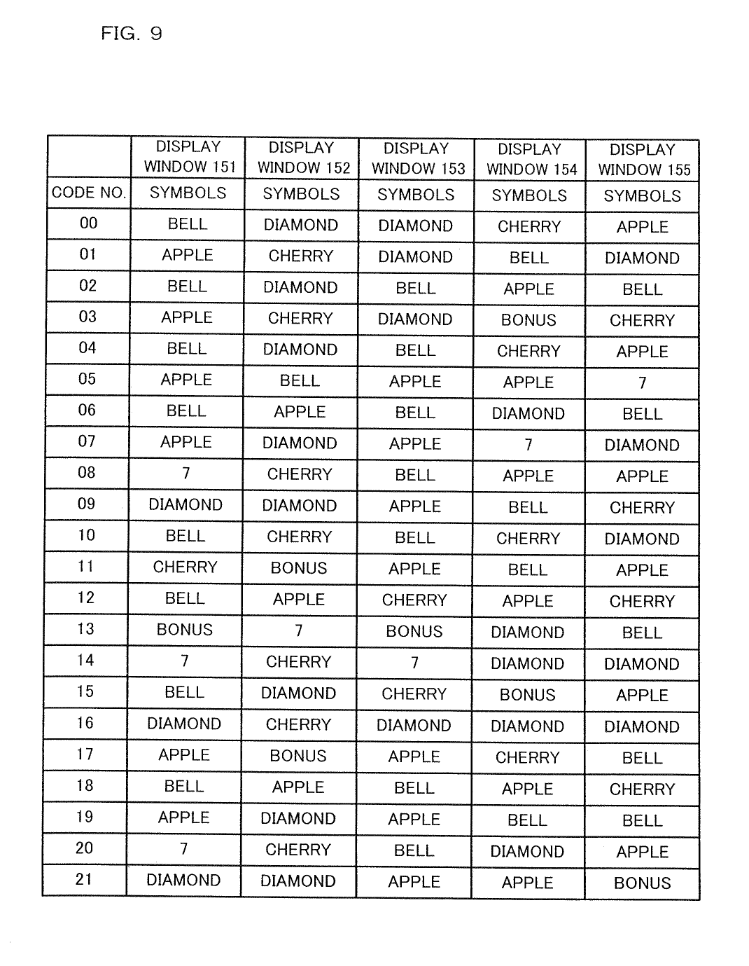

Here, FIG. 3 illustrates a combination symbol arrangements 190a to 190c. The combination symbol arrangement 190a is a row whose y coordinate is 1, the combination symbol arrangement 190b is a row whose coordinate is 2, and the combination symbol arrangement 190c is a row whose y coordinate is 3. The three combination symbol arrangements 190 are determined based on symbols 180 and an arrangement thereof in arrangement areas 150 whose respective x coordinates are the same, and whose respective y coordinates are different from one another. However, it is possible to determine the combination symbol arrangements 190 based on symbols 180 and an arrangement thereof in arrangement areas 150 whose respective x coordinates are different from one another, and whose respective y coordinates are the same. Further, FIG. 6 illustrates a combination symbol arrangements 190a and 190c. The combination symbol arrangements 190a are rows whose y coordinates are both 1, and the combination symbol arrangement 190c is a row whose y coordinate is 3. As is obvious from this example, the combination symbol arrangements 190 may include the combination symbol arrangements 190a whose respective x and y coordinates are the same. Thus, the combination symbol arrangements 190 are determined based on: symbols 180 and an arrangement thereof in arrangement areas 150 whose respective x coordinates are the same, and whose respective y coordinates are different from one another; or based on symbols 180 and an arrangement thereof in arrangement areas 150 whose respective x coordinates are different from one another, and whose respective y coordinates are the same. This allows players to easily understand how rearranged symbols 180 on the terminal displays 101 are combined and rearranged on the shared display 102. This enhances the feelings of “unity” and “sharing” among participating players.

[Symbol, Combination, or the Like] A terminal display 101 has a matrix 156 including symbol columns each having twenty two symbols 180 as illustrated in FIG. 9. To each of the symbols constituting the columns is given one of code numbers 0 to 21. Each of the symbol columns has a combination of symbols which includes “BELL”, “APPLE”, “7”, “DIAMOND”, “CHERRY”, or “BONUS”.

Of the symbols in the symbol columns, the display windows 151 to 155 each displays (arranges) three successive symbols. The symbols arranged in the upper stages 151a to 155a, the central stages 151b to 155b, and the lower stages 151c to 155c form a symbol matrix having five columns and three rows. When a BET button and a start button are sequentially pressed in this order to start a game, symbols constituting the symbol matrix start to scroll. This scrolling of the symbols stops (rearrangement) after a predetermined period from the beginning of the scrolling.

Further, for each symbol, a predetermined scatter symbol is determined in advance. Scatter symbols are such symbols that a player is put in an advantageous position when a predetermined number or more of them are displayed in the matrix 156. For example, the advantages includes: a state where coins corresponding to the scatter symbols are paid out, a state where the number of coins to be paid out is added to a credit, a state where a bonus game is started.

To be more specific, when three or more symbols of “BONUS” are rearranged in the matrix 156, a bonus is triggered and a gaming state shifts from a base game to a bonus game. Further, when four or more symbols of “BONUS” are displayed in the matrix 156, twenty coins (game medium) are paid out for one bet.

Here, a bonus game is a gaming state which provides a larger advantage than a base game. In this embodiment, the bonus game is a free game. The free game is a game allowing a player to play a game a predetermined number of times without betting a coin. No particular limitation is put on the bonus game, as long as it is a gaming state advantageous to the player, that is, it is more advantageous than the base game. For example, the bonus game may include a state where more game media are obtainable than in the base game, a state where a game medium is obtainable with higher probability than in the base game, a state where a game medium is less consumed than in the base game, and the like. Specifically, a free game, a second game, a feature game, and the like may be mentioned as examples of the bonus game.

[Mechanical Structure of Gaming Machine 1] Next, the following describes a specific example of mechanical and electrical structures of the gaming machine 1 thus structured.

A gaming machine 1 is placed in a gaming facility such as a casino. This gaming machine 1 runs a unit game which involves a game medium. The game medium is a coin, bill, or a value in the form of electronic information. However, the game medium in the present invention is not particularly limited. For example, a medal, token, electronic money, ticket or the like are also possible. Further, the ticket is not particularly limited and may be a later-described ticket with a barcode or the like ticket.

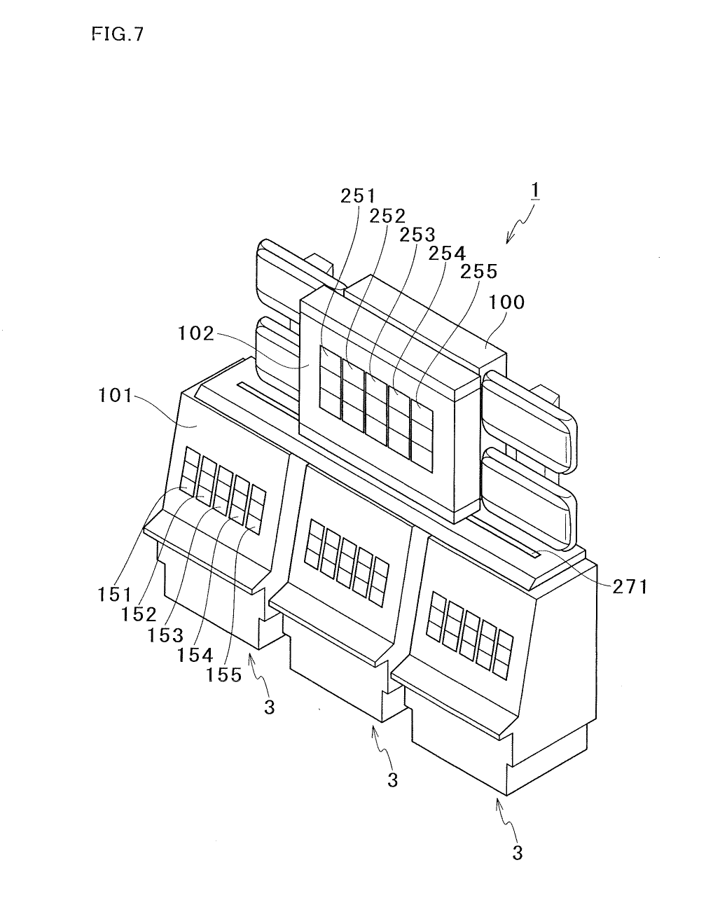

As illustrated in FIG. 7, the gaming machine 1 includes: gaming terminals 3 which run a game independently from each other; a center controller 100 connected to the gaming terminals 3, which is in communication with the gaming terminals 3 and runs a shared game; a shared display 102 which displays thereon an effect image related to the shared game; a rail 271 which supports the shared display 102 and allows the shared display 102 to move to a position immediately above one of the gaming terminals 3; and a not-shown drive motor 270 which causes the shared display 102 to move along the rail 271.

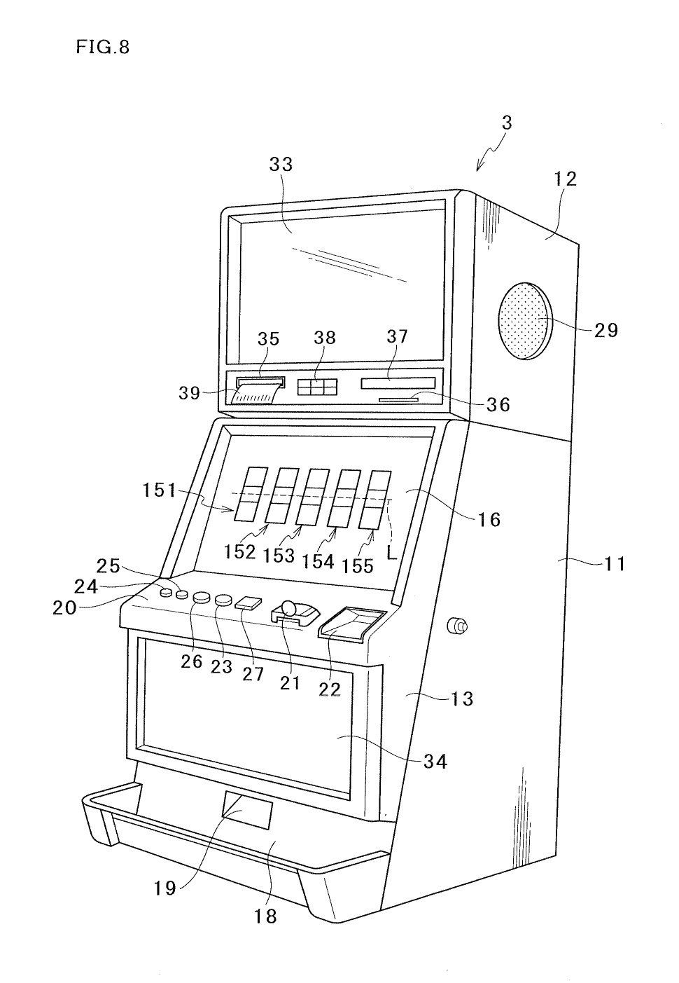

As illustrated in FIG. 8, the gaming terminal 3 includes: a cabinet 11, a top box 12 provided above the cabinet 11, and a main door 13 provided on the front surface of the cabinet 11. The main door 13 has a lower image display panel 16. The lower image display panel 16 has a transparent liquid crystal panel for displaying various information. The lower image display panel 16 displays display windows 151 to 155 (matrix 156) for arranging therein symbols 180. Further, the lower image display panel 16 displays as needed various information and effect images related to a game.

The present embodiment deals with a case where the lower image display panel 16 electrically displays symbols 180 arranged in five rows/three columns. However, the present invention is not limited to this.

The lower image display panel 16 displays a single activated payline L. Note that the number of pay lines L may be two or more. When the number of pay lines L is two or more, the number of pay lines L activated may be determined according to a predetermined condition, such as the number of coins placed as a BET.

Note that the lower image display panel 16 may have a credit value indicator and a payout value indicator. The credit value indicator displays a total value (hereinafter also referred to as total credit value) which a gaming terminal 3 can pay out to a player. When symbols stopped along a pay line L form a winning combination, the payout value indicator displays the number of coins to be paid out.

Further, scatter symbols may be adopted, and the number of coins to be paid out may be determined, according to the number of scatter symbols displayed on the matrix 156. Note that the pay line L does not necessarily have to be displayed.

Below the lower image display panel 16 provided are a control panel 20, a coin insertion slot 21, and a bill validator 22. The control panel 20 is provided with various buttons 23 to 27. These buttons 23 to 27 allow a player to input instructions related to a game played by the player. Through the coin insertion slot 21, a coin is received in the cabinet 11.

The control panel 20 includes: a spin button 23, a change button 24, a cashout button 25, a 1-BET button 26, and a maximum BET button 27. The spin button 23 is for inputting an instruction to start symbol scrolling. The change button 24 is used to ask a staff person in the gaming facility for exchange of money. The cash out button 25 is for inputting an instruction to pay out coins corresponding to the total credit-value into the coin tray 18.

The 1-BET button 26 is used for betting one coin out of those corresponding to the total credit value. The maximum BET button 27 is used for betting, out of those corresponding to the total credit value, a maximum number of coins (e.g., fifty coins) which can be bet in one game.

The bill validator 22 validates whether bill is genuine or not and receives the genuine bill into the cabinet 11. Note that the bill validator 22 is capable of reading a barcode attached to a later-mentioned ticket 39 having a barcode (hereinafter simply referred to as ticket 39). When the bill validator 22 reads the ticket 39, it outputs to the main CPU 41 a read signal representing information having read from the barcode.

On the lower front surface of the main door 13, that is, below the control panel 20, a berry glass 34 is provided. On the belly glass, a character of a gaming terminal 3 or the like is drawn. On the front surface of top box 12 is provided an upper image display panel 33. The upper image display panel 33 has a liquid crystal panel and displays an effect image, introduction to the game, rules of the game, or the like.

Further, the top box 12 has a speaker 29 for performing an audio output. Below the upper image display panel 33 are provided a ticket printer 35, a card reader 36, a data displayer 37, and a keypad 38. The ticket printer 35 prints, on to a ticket, a barcode having encoded data containing credit-value, date and time, identification number of a gaming terminal 3 or the like, thereby issuing a ticket 39 having a barcode attached thereto. A player can play a game in another gaming terminal 3 with the ticket 39 having the barcode, or exchange the ticket 39 having the barcode with bill or the like at a change booth or the like of the game arcade.

The card reader 36 reads/writes data from/into a smart card. The smart card is carried by a player, and stores therein data for identifying the player, data relating to a history of games played by the player, or the like.

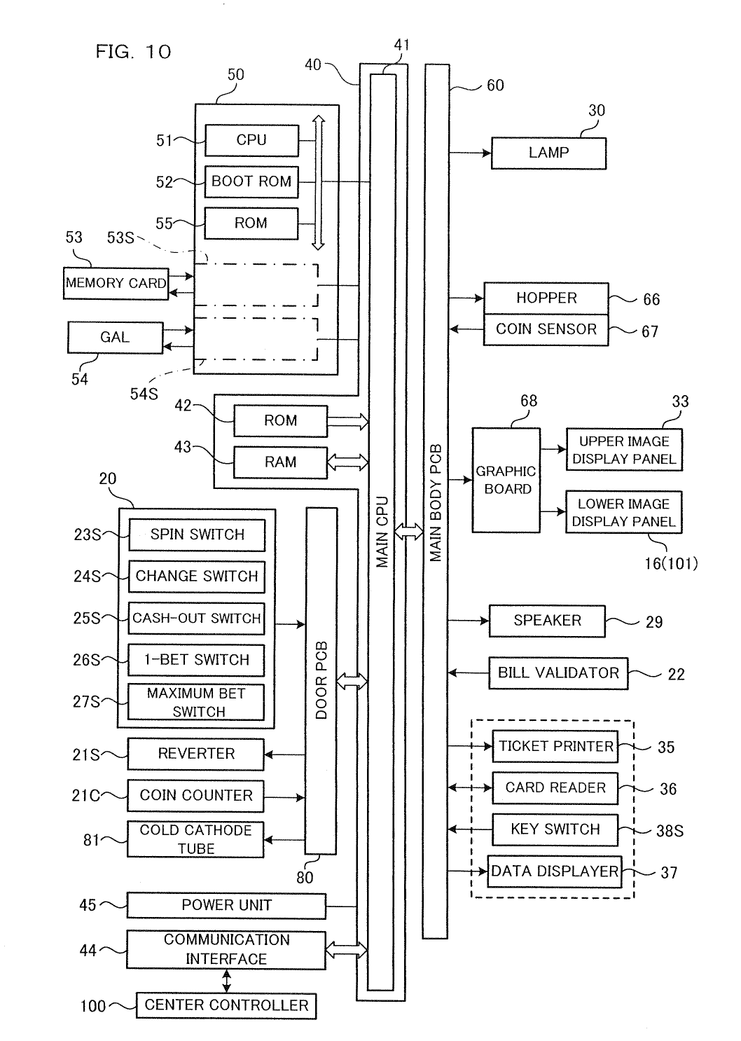

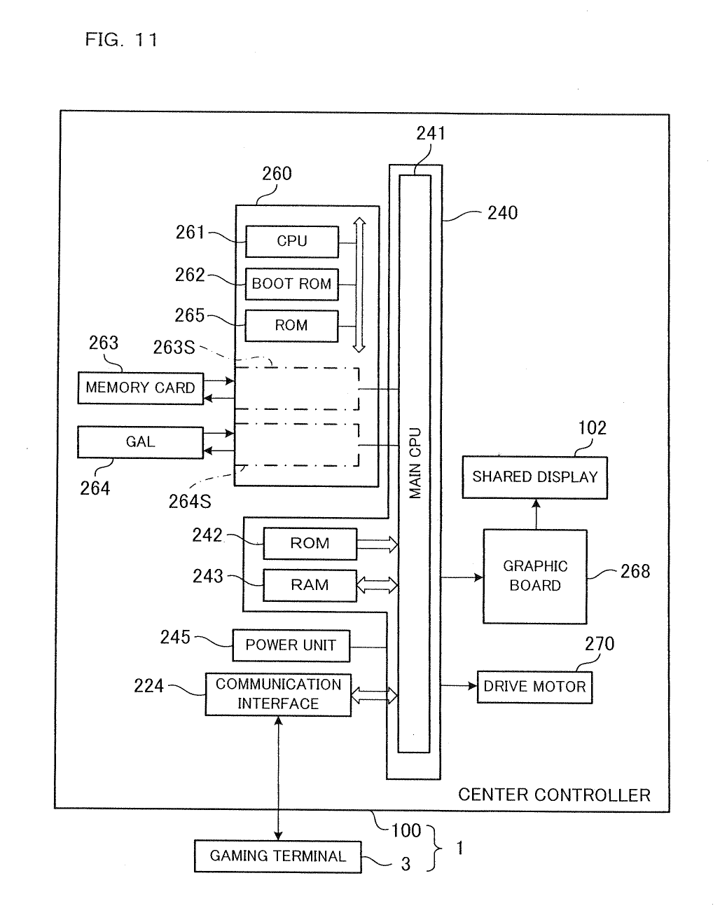

The data displayer 37 includes a fluorescent display or the like, and displays the data read by the card reader 36 and the data input by the player through the keypad 38. The keypad 38 is for entering instructions or data relating to issuing of a ticket or the like.

[Electrical Structure of Gaming Machine 1] FIGS. 10 and 11 are block diagrams each illustrating an electrical structure of the entire gaming machine 1.

[Electrical structure of Gaming Terminal 3] FIG. 10 is a block diagram showing an electrical structure of the entire gaming terminal 3. As illustrated in FIG. 10, the cabinet 11 includes a control unit having a terminal controller 110. The control unit includes a motherboard 40, a main body PCB (Printed Circuit Board) 60, a gaming board 50, a door PCB 80, various switches, sensors, or the like.

The gaming board 50 is provided with a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The stop symbol determining program determines symbols (code number corresponding to the symbol) to be stopped in the arrangement areas 150. This stop symbol determining program contains sets of symbol weighting data respectively corresponding to various payout rates (e.g., 80%, 84%, 88%). Each set of the symbol weighting data indicates, for each of the display windows 151 to 155, a code number of each symbol and at least one random numerical value allotted to the code number. The numerical value is a value within a predetermined range of 0 to 256 for example.

The payout rate is determined based on payout rate setting data output from the GAL 54. Based on a set of the symbol weighting data corresponding to the payout rate determined, a symbol to be stopped is determined.

The memory card 53 stores therein various types of data for use in the game programs and the game system programs. For example, the memory card 53 stores a table listing combinations of a symbol 180 to be displayed on the display windows 151 to 155 of FIG. 1 and an associated range of random numerical values. This data is transferred to the RAM 43 of the motherboard 40, at the time of running a game programs.

The card slot 53S is structured so as to allow the memory card 53 to be attached/detached to/from the card slot 53S. This card slot 53S is connected to the motherboard 40 through an IDE bus. Thus, the type and content of a game run by a gaming terminal 3 can be modified by detaching the memory card 53 from the card slot 53S, write a different game program and a different game system program into the memory card 53, and inserting the memory card 53 back into the card slot 53S.

Each of the game programs includes a program related to the progress of the game and/or a program for causing a transition to a bonus game. Each of the game programs includes image data and audio data output during the game.

The GAL 54 has input and output ports. When the GAL 54 receives data via the input port, it outputs data corresponding to the input data from its output port. This data from the output port is the payout rate setting data described above.

IC socket 54S is structured so as to allow the GAL 54 to be attached/detached to/from the IC socket 54S. The IC socket 54S is connected to the motherboard 40, via a PCI bus. Thus, the payout rate setting data to be output from GAL 54 can be modified by: detaching the GAL 54 from the IC socket 54S, overwriting the program stored in the GAL 54, and attaching the GAL 54 back to the IC socket 54S.

The CPU 51, the ROM 55 and the boot ROM 52 connected through an internal bus are connected to the motherboard 40 through the PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41 (terminal controller 110), a ROM (Read Only Memory) 42, a RAM (Random Access Memory) 43, and a communication interface 44.

The main CPU 41 serves as a terminal controller 110 and has a function of controlling the entire gaming terminal 3. In particular, the main CPU 41 controls the following operations: an operation of outputting a signal instructing variable-displaying of symbols 180 to the graphic board 68, which is performed in response to pressing of the spin button 23 after betting of credit; an operation of determining symbols 180 to be stopped after the variable-displaying of symbols 180; and an operation of stopping the symbols 180 thus determined in the display window 151 to 155.

In other words, the main CPU 41 serves as an arrangement controller which arranges symbols to form a new symbol matrix through scrolling of symbols displayed on the lower image display panel 16. This main CPU 41 therefore determines symbols to be arranged in a symbol matrix by selecting symbols to be arranged from various kinds of symbols. Then, the main CPU 41 executes arrangement control to stop scrolling the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50. The RAM 43 stores data or a program used for the main CPU 41 to perform a process.

The communication interface 44 is provided to communicate with a host computer and the like equipped in the gaming facility, through the network (communication line). The communication interface 44 is also for communicating with the center controller 100 through a communication line. Further, a main body PCB (Printed Circuit Board) 60 and a door PCB 80 are connected to the motherboard 40, through USB (Universal Serial Bus). Further, the motherboard 40 is connected to a power unit 45. The power unit 45 supplies power to the motherboard 40 to boot the main CPU 41 thereof. Meanwhile, the power unit 45 supplies power to the gaming board 50 through the PCI bus to boot the CPU 51 thereof.

The main body PCB 60 and door PCB 80 are connected to various devices or units which generate signals to be input to the main CPU 41, and various devices or units whose operations are controlled by signals from the main CPU 41. Based on a signal input to the main CPU 41, the main CPU 41 runs the game program and the game system program stored in the RAM 43, to perform an arithmetic process. Then, the CPU 41 stores the result of the arithmetic process in the RAM 43, or transmits a control signal to the various devices and units to control them based on the result.

The main body PCB 60 is connected with a lamp 30, a hopper 66, a coin sensor 67, a graphic board 68, the speaker 29, a bill validator 22, a ticket printer 35, a card reader 36, a key switch 38S, and a data displayer 37.

The lamp 30 is turned on/off on the basis of a control signal from the main CPU 41.

The hopper 66 is mounted in the cabinet 11 and pays out a predetermined number of coins from a coin outlet 19 to the coin tray 18, based on a control signal from the main CPU 41. The coin sensor 67 is provided inside the coin outlet 19, and outputs a signal to be input to the main CPU 41 upon sensing that a predetermined number of coins have been delivered from the coin outlet 19.

The graphic board 68 controls image displaying of upper image display panel 33 and the lower image display panel 16, based on a control signal from the main CPU 41. Further, the graphic board 68 is provided with a VDP (Video Display Processor) for generating image data on the basis of a control signal from the main CPU 41, a video RAM for temporarily storing the image data generated by the VDP, or the like. Note that image data used at the time of generating the image data by the VDP is in a game program which is read out from the memory card 53 and stored in the RAM 43.

The bill validator 22 reads an image on the bill and takes only those recognized as to be genuine into the cabinet 11. When taking in a genuine bill, the bill validator 22 outputs an input signal indicating the value of the bill to the main CPU 41. The main CPU 41 stores into the RAM 43 a credit-value corresponding to the value of the bill indicated by the signal.

The ticket printer 35 prints a barcode on to a ticket to issue a ticket 39 having the barcode. The barcode contains encoded data such as credit-value stored in the RAM 43, date and time, identification number of the gaming terminal 3, or the like, based on a control signal from the main CPU 41.

The card reader 36 reads out data from the smart card and transmits the data to the main CPU 41. Further, the card reader 36 writes data into the smart card based on the control signal output from the main CPU 41. The key switch 38S is mounted to the keypad 38, and outputs a signal to the main CPU 41 in response to an operation of the keypad 38 by the player. The data displayer 37 displays, based on a control signal from the main CPU 41, the data read by the card reader 36 or the data input by the player through the key pad 38.

The door PCB 80 is connected to a control panel 20, a reverter 21S, a coin counter 21C, and a cold cathode tube 81. The control panel 20 is provided with: a spin switch 23S associated with the spin button 23; a change switch 24S associated with the change button 24; a cashout switch 25S associated with the cashout button 25; a 1-BET switch 26S associated with the 1-BET button 26; and a maximum BET switch 27S associated with the maximum BET button 27. Each of the switches 23S to 27S outputs a signal to the main CPU 41, when a player presses the associated button.

The coin counter 21C is provided within the coin insertion slot 21, and identifies whether the coin inserted into the coin insertion slot 12 by the player is genuine. A coin except the genuine coin is discharged from the coin outlet 19. In addition, the coin counter 21C outputs an input signal to the main CPU 41 upon detection of a genuine coin.

The reverter 21S is operated on the basis of the control signal output from the main CPU 41 and distributes a coin, which is recognized as a genuine coin by the coin counter 21C, to a not-shown cash box or hopper 66 mounted in the gaming terminal 3. In other words, when the hopper 66 is full of the coins, the genuine coin is distributed into the cash box by the reverter 21S. On the other hand, when the hopper 66 is not yet full with the coins, the genuine coin is distributed into the hopper 66. The cold cathode tube 81 functions as a backlight mounted to rear sides of the lower image display panel 16 and the upper image display panel 33. This cold cathode tube 81 turns on according to a control signal from the main CPU 41.

[Electrical Structure of Center Controller 100] FIG. 11 is a block diagram illustrating an electrical structure of the center controller 100. The center controller 100 is provided therein with a control unit. As illustrated in FIG. 11, the control unit includes a motherboard 240, a gaming board 260, an actuator, or the like.

The gaming board 260 has the same structure as that of the gaming board 50. The motherboard 240 has the same structure as that of the motherboard 40. The communication interface 244 communicates with the terminal controller 110 through a communication line.

The graphic board 268 has the same structure as that of the graphic board 68, except in that the graphic board 268 controls image displaying of the shared display 102 based on a control signal from the main CPU 241.

The drive motor 270 is a stepping motor and is connected to a not-shown drive wheel. The drive motor 270 is driven by a control signal from the main CPU 241, and rotates the drive wheel to move the shared display 102.

[Operation of Gaming Machine 1: Boot Process]

The following describes a boot process routine which takes place in the gaming machine 1. Upon powering on the gaming machine 1, a boot process starts in: the mother board 240 and gaming board 260 in the center controller 100, and in the mother board 40 and the gaming board 50 in the terminal controller 110. The memory cards 53 and 263 are assumed to be inserted into the card slots 53S and 263S of the gaming boards 50 and 260, respectively. Further, the GALs 54 and 264 are assumed to be attached to the IC sockets 54S and 264S, respectively.

First, turning on the power switch of (powering on) the power units 45 and 245 boots the motherboards 40 and 240, and the gaming boards 50 and 260. Booting the motherboards 40 and 240 and the gaming boards 50 and 260 starts separate processes in parallel. Specifically, the CPUs 51 and 261 read out preliminary authentication programs stored in the boot ROMs 52 and 262, respectively. Then, preliminary authentication is performed according to the read out programs so as to confirm and authenticate that no modification is made to authentication programs, before reading them in the motherboards 40 and 240, respectively (S1). Meanwhile, the main CPUs 41 and 241 of the motherboards 40 and 240 run BIOS stored in the ROMs 42 and 242 to load into the RAMs 43 and 243 compressed data built in the BIOS, respectively (S2). Then, the main CPUs 41 and 241 run a procedure of the BIOS according to the data loaded into the RAMs 43 and 243 so as to diagnose and initialize various peripheral devices (S3).

The main CPUs 41 and 241, which are respectively connected to the ROMs 55 and 265 of the gaming boards 50 and 260 via PCI buses, read out authentication programs stored in the ROMs 55 and 265 and stores them in the RAMs 43 and 243 (S4). During this step, the main CPUs 41 and 241 each derives a checksum through ADDSUM method (a standard check function) which is adopted in a standard BIOS, and store the authentication programs into RAMs 43 and 243 while confirming if the operation of storing is carried out without an error.

Next, the main CPUs 41 and 241 each checks what connects to the IDE bus. Then, the main CPUs 41 and 241 access, via the IDE buses, to the memory cards 53 and 263 inserted into the card slots 53S and 263S, and read out game programs and game system programs from the memory cards 53 and 263, respectively. In this case, the CPUs 41 and 241 each reads out four bytes of data constituting the game program and the game system program at one time. Next, the CPUs 41 and 241 authenticate the game program and the game system program read out to confirm and prove that these programs are not modified (S5).

When the authentication properly ends, the main CPUs 41 and 241 write and store the authenticated game programs and game system programs in RAMs 43 and 243 (S6).

Next, the main CPUs 41 and 241 access, via the PCI buses, to the GALs 54 and 264 attached to the IC socket 54S·264S, and read out payout rate setting data from the GALs 54 and 264, respectively. The payout rate setting data read out is then written and stored in the RAMs 43 and 243 (S7).

Next, the main CPUs 41 and 241 read out, via the PCI buses, country identification information stored in the ROMs 55 and 265 of the gaming boards 50 and 265, respectively. The country identification information read out is then stored in the RAMs 43 and 243 (S8).

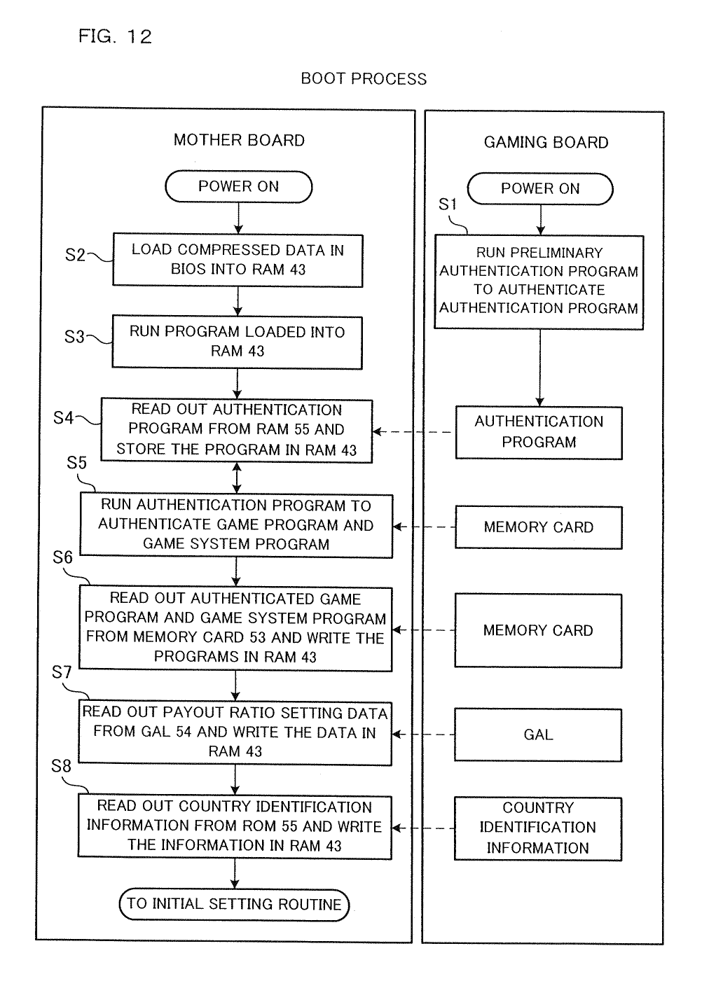

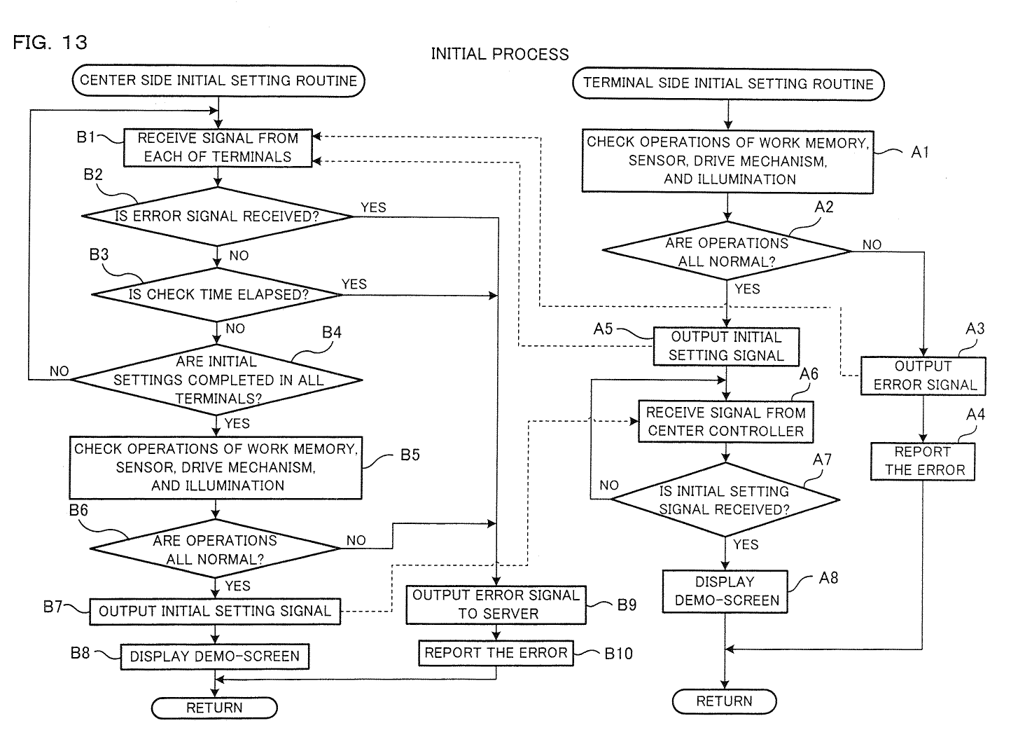

After this, the main CPU 41 and 241 each performs an initial process of FIG. 13.

[Operation of Gaming Machine 1: Initial Process] The following describes an initial process which takes place in the gaming machine 1. When the boot process of FIG. 12 is completed, the center controller 100 reads out from the RAM 243 a center side initial setting routine illustrated in FIG. 13 and executes the routine. Meanwhile, the gaming terminal 3 reads out from the RAM 43 a terminal side initial setting routine illustrated in FIG. 13 and executes the routine. The center side and terminal side initial setting routines are executed in parallel.

First, the main CPU 41 of each of the gaming terminals 3 checks operations of work memories such as the RAM 43, various sensors, various driving mechanisms, and various decorative illuminations (A1). Then, the main CPU 41 determines if all the check results are normal (A2). If the main CPU 41 determines that the check results contains an error (A2: NO), the main CPU 41 outputs a signal notifying the error (hereinafter, error signal) to the center controller 100 (A3). Further, the main CPU 41 reports the error in the form of illuminating the lamp 30 or the like (A4), and then ends the routine.

On the other hand in A2, if the main CPU 41 determines that all the check results are normal (A2: YES), an initial setting signal is output to the center controller 100 (A5). Then, an initial setting signal is waited from the center controller 100 (A6, A7: NO).

The main CPU 241 of the center controller 100 receives signals from each of the terminals (B1). Then, the main CPU 241 determines whether a signal received is an error signal (B2). If the main CPU 241 determines that the signal is an error signal (B2: YES), the main CPU 241 outputs the error signal to a server of a not-shown host computer or the like (B9) to report the error (B10), and ends the routine.

On the other hand in B2, if the main CPU 241 determines that the signal is not an error signal (B2:NO), the main CPU 241 determines whether a predetermined time (check time) has elapsed from the time of powering on (B3). If the main CPU 241 determines that the check time has elapsed (B3: YES), B9 is executed. On the other hand, if the main CPU 241 determines that the check time has not yet elapsed (B3:NO), it is determined whether an initial setting signal is received from each of the gaming terminals 3 (B4). If the main CPU 241 determines that an initial setting signal from any one of the gaming terminals 3 is not received (B4: NO), the process returns to B1. On the other hand, if it is determined that initial setting signals from all the gaming terminals 3 are received (B4: YES), the main CPU 241 checks operations of work memories such as RAM 243 or the like, various sensors, various driving mechanisms, and various decorative illuminations (B5). Then, the main CPU 241 determines whether all the check results are normal (B6) If the main CPU 241 determines the check results contain an error (B6: NO), the main CPU 241 executes B9.

On the other hand in B6, if the main CPU 241 determines that all the check results are normal (B6: YES), the main CPU 241 outputs an initial setting signal to all the gaming terminals 3 (B7), and causes the shared display 102 to display a demo-screen (B8). Then, the main CPU 241 ends the routine.

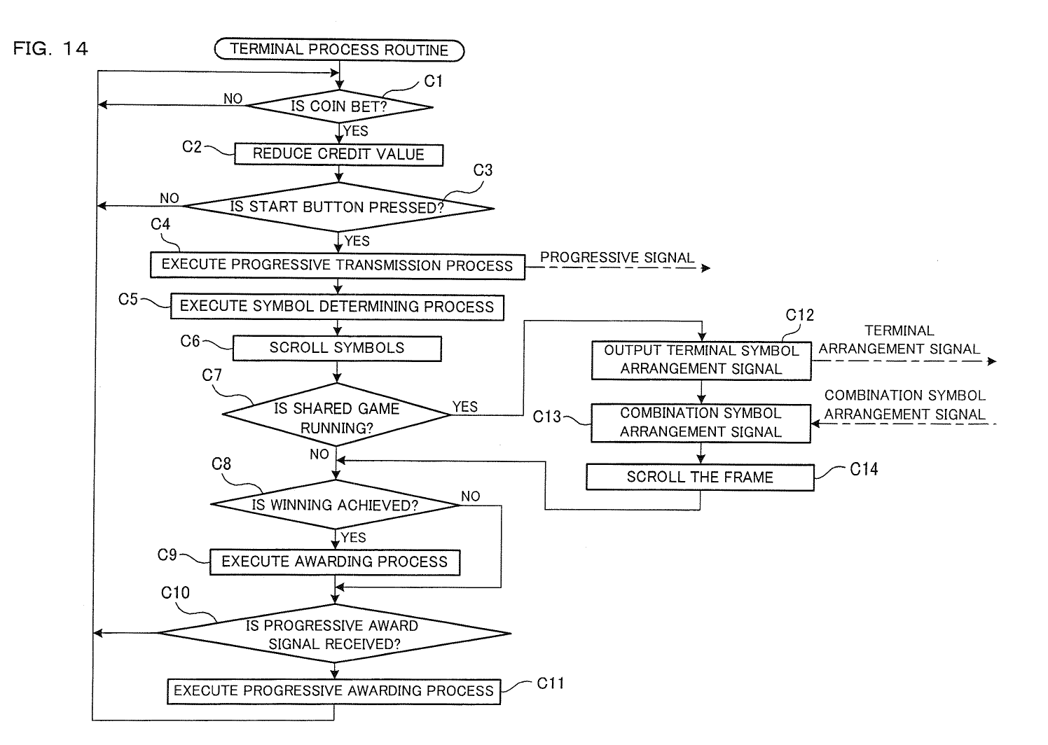

In A7, the main CPU 41 of each of the gaming terminals 3 determines that an initial setting signal is received from the center controller 100 (A7: YES), and causes the terminal display 101 to display a demo-screen (A7). The main CPU 41 then ends the routine.

[Operation of Gaming Terminal 3: Terminal Process Routine] After the terminal side initial setting routine of FIG. 13, the main CPU 41 of the gaming terminal 3 performs a terminal process routine of FIG. 14. Through this terminal process routine, a game is run.

As illustrated in FIG. 14, in the terminal process routine, it is determined whether a coin is bet (C1). In this step, it is determined whether a signal from the 1-BET switch 26S entered by pressing of the 1-BET button 26 is received. Meanwhile, it is determined whether a signal from the maximum BET switch 27S entered by pressing of the maximum BET button 27 is received. If no coin is BET (C1: NO), C1 is repeated until a coin is bet.

On the other hand, if a coin is bet (C1: YES), the credit value stored in the RAM 43 is reduced according to the number of coins bet (C2). When the number of coins bet surpasses the number of coins equivalent to the credit value stored in the RAM 43, C2 is repeated without the reduction of the credit value. When the number of coins bet exceeds the maximum number of coins bettable one game (50 pieces in this embodiment), the process goes to a later-described step C3 without the reduction of the credit value.

Then, it is determined whether a spin button 23 is pressed (C3). If the spin button 23 is not pressed (C3: NO), the process returns to C1. Here, if the spin button 23 is not pressed (for example, the spin button 23 is not pressed but a command to end the game is input), the reduction of the credit value in C2 is canceled.

On the other hand, when the spin button 23 is pressed (C3: YES), a progressive transmission process is executed (C4). In other words, a progressive signal indicating a part of the game value bet is transmitted to the center controller 100.

Next executed is a symbol determining process (C5). That is, the stop symbol determining program stored in the RAM 43 is run to determine symbols 180 to be arranged in the matrix 156. Through this, a symbol combination to be formed along the payline L is determined.

Then, the scrolling process is executed to scroll symbols 180 on the terminal display 101 (C6). The scrolling process is a process in which the symbols 180 determined in C5 are stopped (rearranged) in the matrix 156 after scrolling of symbols 180 in a direction indicated by an arrow symbol.

Next, the CPU 41 determines whether a shared game is running (C7). If a shared game start signal is received from the center controller 100, the CPU 41 determines that the shared game is running. If the CPU 41 determines that the shared game is running (C7: YES), a terminal symbol arrangement signal is transmitted to the center controller 100 (C12). The terminal symbol arrangement signal indicates symbols 180 rearranged in the arrangement areas 150 and an arrangement of the symbols 180 (terminal symbol arrangement). Next, the main CPU 41 receives a combination symbol arrangement signal from the center controller 100 (C13). The combination symbol arrangement signal indicates a combination symbol arrangement 190 determined by the center controller 100 based on the terminal symbol arrangement signal resulting from C12. Next, the main CPU 41 causes the terminal display 101 to scroll the frame. Then, the main CPU 41 stops scrolling the frame so as to present in the frame the combination symbol arrangement 190 received in C12 (C14). On the other hand in C7, if it is determined that no shared game is running (C7: NO), C8 is executed.

Next, it is determined whether symbols 180 rearranged in the matrix 156 form a winning combination (C8). If the symbols 180 forms a winning combination (C8: YES), a payout process is executed (C9). More specifically, when a winning combination is formed, the number of coins according to the combination is calculated. On the other hand in C8, if it is determined that no winning combination is formed (C8: NO), C10 is executed.

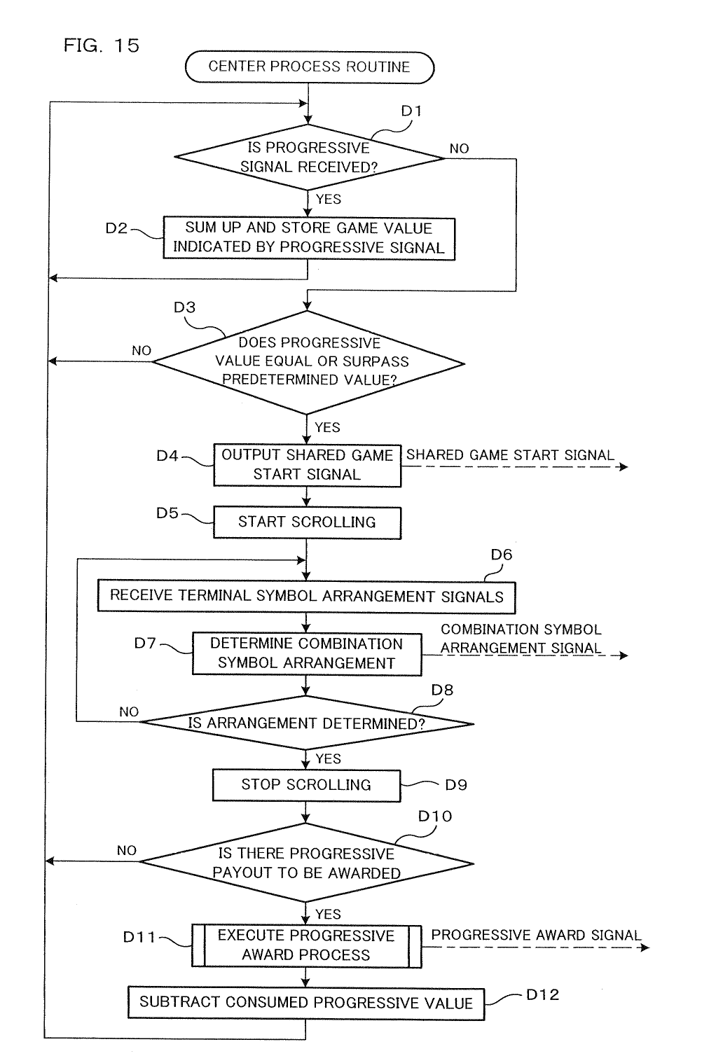

Next, the main CPU 41 determines whether a progressive award signal is received from the center controller 100 (C10). If the CPU 41 determines that a progressive award signal is received (C10:YES), a payout is awarded according to the progressive award signal (C11). The process then returns to C1. On the other hand in C10, if the CPU 41 determines that no progressive award signal is received (C10: NO), the process returns to C1.

[Operation of Center Controller 100: Center Process Routine] After the center side initial setting routine of FIG. 13, the main CPU 241 of the center controller 100 executes a center process routine of FIG. 15. The main CPU 241 performs the center process routine to run a shared game.

As illustrated in FIG. 15, in the center process routine, the main CPU 241 determines whether a progressive signal is received from a gaming terminal 3 (D1). If the main CPU 241 determines that a progressive signal is received (D1:YES), a game value indicated by the progressive signal is stored and summed (D2). The process then returns to D1.

On the other hand in D1, if the main CPU 241 determines no progressive signal is received (D1: NO), the main CPU 241 determines if the progressive value equals or surpasses a predetermined value (D3). If the main CPU 241 determines that the progressive value is less than the predetermined value (D3: NO), the process returns to D1. On the other hand, if the main CPU 241 determines that the progressive value equals or surpasses the predetermined value (D3: YES), a shared game start signal is output to each of the gaming terminals 3 (D4) Next, the main CPU 241 causes the shared display 102 to start scrolling symbols 180 (D5). Next, a terminal symbol arrangement signal is received from each of the gaming terminals 3 (D6). Based on the terminal symbol arrangement signal, a combination symbol arrangement 190 is determined. The combination symbol arrangement 190 thus determined is sent back to the gaming terminals 3 (D7).

Next, the main CPU 241 combines at least two combination symbol arrangements 190 determined in D7, and tries to determine symbols 180 and an arrangement of the symbols 180 to be arranged in the arrangement areas 250 of the shared display 102 (D8). If an arrangement is not determined (D8: NO), the process returns to D6. On the other hand, if an arrangement is determined (D8: YES), the scrolling of the symbols 180 on the shared display 102 is stopped to present the arrangement determined (D9).

Then, the main CPU 241 determines whether the symbols 180 arranged on the shared display 102 forms a winning combination (D10). If the main CPU 241 determines that no winning combination is formed (D10: NO), the process returns to D1. On the other hand, if the main CPU 241 determines that a winning combination is formed (D10:YES), a progressive award process for awarding a progressive payout is executed to transmit a progressive award signal to a corresponding gaming terminal 3 (D11). Then, a progressive value consumed is subtracted from the value stored in RAM 243 (D12), and the process returns to D1.

As is already mentioned, a payout awarded according to a relation among the symbols 180 rearranged on the shared display 102 realizes a new entertainment characteristic which raises player's expectation for another payout in addition to the one awarded as a result of the game run in the gaming terminal.

Further, as is already mentioned, a single game involving a plurality of gaming terminals is created by rearranging, on the shared display 102, symbols 180 identical to those in one symbol arrangement 190 of one gaming terminal 3 in combination with symbols 180 identical to those in another symbol arrangement 190 of another gaming terminal 3. This realizes a new entertainment characteristic which gives the feelings of “unity” and “sharing” to participating players.

Further, as is already mentioned, the symbols 180 identical to those in the one symbol arrangement 190 and the symbols 180 identical to those in the other symbol arrangement 190 are combined and rearranged, on the row or column basis, on the shared display 102. A player therefore is able to easily understand how rearranged symbols on the terminal displays 101 are combined and rearranged on the shared display 102. This characteristic enhances the feelings of “unity” and “sharing” among the players.

On the shared display are rearranged symbols 180 identical to those in one symbol arrangement 190 of one gaming terminal 3 and symbols 180 identical to those in another symbol arrangement 190 of another gaming terminal 3. The positions of the one symbol arrangement 190 of one gaming terminal 3 and the other symbol arrangement 190 of the other gaming terminal 3 along the x coordinate axis or y coordinate axis are different from each other. A player therefore is able to easily understand how rearranged symbols on the terminal displays 101 are combined and rearranged on the shared display 102. This characteristic enhances the feelings of “unity” and “sharing” among the players.

Note that the present embodiment deals with a case where the center controller 100 determines a combination symbol arrangement based on a terminal symbol arrangement. However, the present invention is not limited to this. For example, it may be the terminal controller 110 which determines a combination symbol arrangement based on a terminal symbol arrangement.

Note further that the number of gaming terminals 3 is three in the present embodiment. However, the present invention is not limited to this, provided that at least two gaming terminals 3 are provided.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer or computer network. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes performed in the steps or blocks, these processes are essentially executed by various devices. Further, the other structures necessary for the steps or blocks are obvious from the above descriptions.

What is claimed is:

1. A gaming machine comprising:
a plurality of gaming terminals capable of running a game independently from each other, each of which terminals includes a terminal display having a matrix of arrangement areas and which arranges a plurality of symbols in the arrangement areas;
a shared display for arranging therein a plurality of symbols;
a controller programmed to perform the steps of:
(a1) rearranging symbols in the arrangement areas of each of the gaming terminals, based on running of a game in the gaming terminal;
(a2) awarding a payout according to a relation among the symbols rearranged in the arrangement areas;
(a3) combining one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and
(a4) awarding a payout according to a relation among the symbols rearranged on the shared display.

2. A gaming machine comprising:
a plurality of gaming terminals capable of running a game independently from each other, each of which terminals includes a terminal display having a matrix of arrangement areas and which arranges a plurality of symbols in the arrangement areas;
a shared display for arranging therein a plurality of symbols;
a controller programmed to perform the steps of:
(b1) rearranging symbols in the arrangement areas of each of the gaming terminals, based on running of a game in the gaming terminal;
(b2) awarding a payout according to a relation among the symbols rearranged in the arrangement areas;
(b3) combining, on the row or column basis, one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and
(b4) awarding a payout according to a relation among the symbols rearranged on the shared display.

3. A gaming machine comprising:
a plurality of gaming terminals capable of running a game independently from each other, each of which terminals includes a terminal display having a matrix of arrangement areas and which arranges a plurality of symbols in the arrangement areas;
a shared display for arranging therein a plurality of symbols;
a controller programmed to perform the steps of:
(c1) rearranging symbols in the arrangement areas of each of the gaming terminals, based on running of a game in the gaming terminal;
(c2) awarding a payout according to a relation among the symbols rearranged in the arrangement areas;
(c3) combining a symbol arrangement of one gaming terminal with another symbol arrangement of another gaming terminal, and rearranging, on the shared display, symbols corresponding to those in the one symbol arrangement and the other symbol arrangement, wherein the one symbol arrangement includes symbols arranged on the one gaming terminal, and the other symbol arrangement includes symbols arranged on the other gaming terminal; and the positions of the one symbol arrangement and the other symbol arrangement along x coordinate axis or y coordinate axis are different from each other; and
(c4) awarding a payout according to a relation among the symbols rearranged on the shared display.

4. A gaming machine comprising:
a plurality of gaming terminals capable of running a game independently from each other, each of which terminals includes a terminal display having a matrix of arrangement areas and which arranges a plurality of symbols in the arrangement areas;
a shared display for arranging therein a plurality of symbols;
a controller programmed to perform the steps of:
(d1) rearranging symbols in the arrangement areas of each of the gaming terminals, based on running of a game in the gaming terminal;
(d2) awarding a payout according to a relation among the symbols rearranged in the arrangement areas;
(d3) combining a symbol arrangement of one gaming terminal with another symbol arrangement of another gaming terminal, and rearranging, on the shared display, symbols corresponding to those in the one symbol arrangement and the other symbol arrangement, wherein the one symbol arrangement includes symbols arranged in a row or a column on the one gaming terminal, and the other symbol arrangement includes symbols arranged in a row or a column on the other gaming terminal; and the positions of the one symbol arrangement and the other symbol arrangement along x coordinate axis or y coordinate axis are different from each other; and
(d4) awarding a payout according to a relation among the symbols rearranged on the shared display.

5. A playing method of a gaming machine, in which a plurality of symbols are arranged in a matrix of arrangement areas on terminal displays of a plurality of gaming terminals,
the method comprising the steps of:
(e1) rearranging symbols in the arrangement areas of each of the gaming terminals, based on running of a game in the gaming terminal;
(e2) awarding a payout according to a relation among the symbols rearranged in the arrangement areas;
(e3) combining one symbol arrangement of one gaming terminal with another symbol arrangement of another gaming terminal, and rearranging, on a shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal; and
(e4) awarding a payout according to a relation among the symbols rearranged on the shared display.

6. A gaming machine, comprising:
a plurality of gaming terminals each includes (i) a terminal display having a matrix of arrangement areas, which rearranges a plurality of symbols in the arrangement areas, and (ii) a terminal controller; a shared display for arranging therein a plurality of symbols; a center controller, wherein:
the terminal controller is programmed to perform the steps of
(f1) rearranging symbols in the arrangement areas at a predetermined timing,
(f2) awarding a payout according to a relation among the symbols rearranged in the arrangement areas, and
(f3) when a predetermined condition is met, transmitting to the center controller symbols arranged in the arrangement areas and an arrangement of the symbols; and
the center controller is programmed to perform the steps of
(g1) when the predetermined condition is met, receiving from each of the gaming terminals symbols arranged in the arrangement areas and an arrangement of the symbols,
(g2) combining one symbol arrangement of one gaming terminal with another symbol arrangement of another gaming terminal, and rearranging, on the shared display, symbols identical to those in the one symbol arrangement and the other symbol arrangement, wherein the one symbol arrangement includes the symbols arranged in arrangement areas of the one gaming terminal, and the other symbol arrangement includes the symbols arranged in arrangement areas of the other gaming terminal, and
(g3) awarding a payout according to a relation among the symbols rearranged on the shared display.
